(19) United States
(12) Patent Application Publication
(10) Pub. No.: US 2025/0087944 A1
(43) Pub. Date: Mar. 13, 2025

(54) Connector and Connector Assembly

(71) Applicants: Tyco Electronics Technology (SIP) Ltd., Suzhou (CN); Tyco Electronics (Shanghai) Co., Ltd., Shanghai (CN)

(72) Inventors: Yunji He, Suzhou (CN); Jianjia Qi, Shanghai (CN); Feng (Carlos) Pan, Suzhou (CN)

(73) Assignees: Tyco Electronics Technology (SIP) Ltd., Suzhou (CN); Tyco Electronics (Shanghai) Co., Ltd., Shanghai (CN)

(21) Appl. No.: 18/827,055

(22) Filed: Sep. 6, 2024

(30) Foreign Application Priority Data
Sep. 8, 2023 (CN) 202322437519.3

(51) Int. Cl. H01R 13/6581; H01R 13/6594

(52) U.S. Cl. CPC H01R 13/6581; H01R 13/6594

(57) ABSTRACT

A connector includes a shielding shell having a plurality of sockets and a plurality of terminal modules respectively inserted into the sockets. The terminal modules include a signal terminal module for transmitting signals and a power terminal module for transmitting power. The signal terminal module includes a signal terminal holder and a signal terminal provided in the signal terminal holder. The power terminal module includes a power terminal holder and a power terminal provided in the power terminal holder.

### CROSS-REFERENCE TO RELATED APPLICATION

This application claims the benefit of the filing date under 35 U.S.C. § 119 (a)-(d) of Chinese Patent Application No. 202322437519.3, filed on Sep. 8, 2023.

### FIELD OF THE INVENTION

The present invention relates to a connector and a connector assembly comprising the connector.

### BACKGROUND OF THE INVENTION

A connector usually only has a differential signal terminal module and no power terminal module for transmitting power, which limits its use and cannot be applied in situations that require both signal and power transmission.

### SUMMARY OF THE INVENTION

A connector includes a shielding shell having a plurality of sockets and a plurality of terminal modules respectively inserted into the sockets. The terminal modules include a signal terminal module for transmitting signals and a power terminal module for transmitting power. The signal terminal module includes a signal terminal holder and a signal terminal provided in the signal terminal holder. The power terminal module includes a power terminal holder and a power terminal provided in the power terminal holder.

### BRIEF DESCRIPTION OF THE DRAWINGS

Features of the present invention will become more apparent by describing in detail exemplary embodiments thereof with reference to the accompanying drawings, in which:

FIG. 1 shows an illustrative perspective view of the connector according to a first embodiment when viewed from the front side;

FIG. 2 shows an illustrative perspective view of the connector according to the first embodiment when viewed from the rear side;

FIG. 3 shows an illustrative exploded view of the connector according to the first embodiment when viewed from the front side;

FIG. 4 shows an illustrative exploded view of the connector according to the first embodiment when viewed from the rear side;

FIG. 5 shows an illustrative perspective view of a signal terminal module of a connector according to the first embodiment;

FIG. 6 shows an illustrative perspective view of a power terminal module of a connector according to the first embodiment;

FIG. 7 shows an illustrative perspective view of a connector according to a second embodiment;

FIG. 8 shows an illustrative exploded view of the connector according to the second embodiment when viewed from the front side;

FIG. 9 shows an illustrative exploded view of the connector according to the second embodiment when viewed from the rear side;

FIG. 10 shows an illustrative perspective view of a signal terminal module of a connector according to the second embodiment;

FIG. 11 shows an illustrative perspective view of a power terminal module of a connector according to the second embodiment; and

FIG. 12 shows an illustrative perspective view of the locking member, signal terminal module, and power terminal module of the connector according to the second embodiment.

### DETAILED DESCRIPTION

Exemplary embodiments of the present disclosure will be described hereinafter in detail with reference to the attached drawings, wherein like reference numerals refer to like elements. The present disclosure may, however, be embodied in many different forms and should not be construed as being limited to the embodiments set forth herein; rather, these embodiments are provided so that the present disclosure will convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

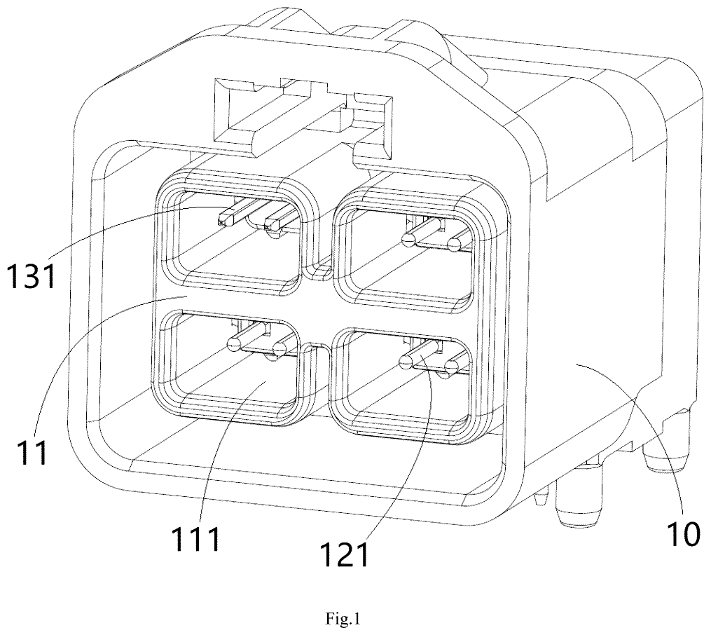

As shown in FIGS. 1 to 6, in an exemplary embodiment of the present invention, a connector is disclosed. The connector includes a shielding shell 11 and a plurality of terminal modules 12 and 13. The shielding shell 11 is formed with a plurality of sockets 111. The terminal modules 12 and 13 are respectively inserted into the sockets 111. The terminal modules 12 and 13 include a signal terminal module 12 for transmitting signals and a power terminal module 13 for transmitting power. The signal terminal module 12 includes a signal terminal holder 120 and a signal terminal 121 set in the signal terminal holder 120. The power terminal module 13 includes a power terminal holder 130 and a power terminal 131 set in the power terminal holder 130.

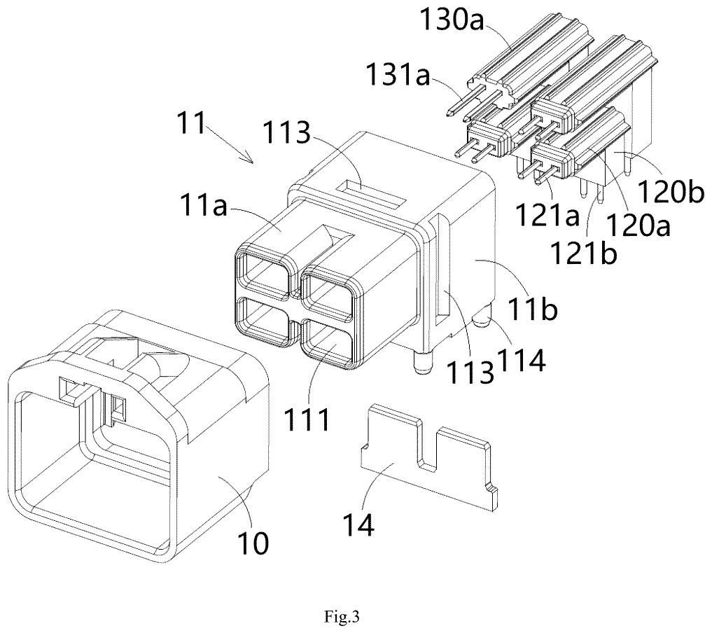

As shown in FIG. 3, in the illustrated embodiments, the shielding shell 11 comprises a front shell part 11a and a rear shell part 11b, with the sockets 111 formed in the front shell part 11a and extending in a horizontal direction. The front parts of the terminal modules 12 and 13 extend in the horizontal direction and are respectively inserted into multiple sockets 111 of the front shell part 11a.

As shown in FIGS. 3 to 6, in the illustrated embodiments, the front part 120a of the signal terminal holder 120 and the front part 121a of the signal terminal 121 extend in the horizontal direction and are inserted into the corresponding socket 111 of the front shell part 11a. The front part 130a of the power terminal holder 130 and the front part 131a of the power terminal 131 extend in the horizontal direction and are inserted into the corresponding socket 111 of the front shell 11a.

In the illustrated embodiments, the front shell part 11a of the shielding shell 11 is used for mating with a mating shielding shell of a mating connector, and the rear shell part 11b of the shielding shell 11 is used for connecting to a circuit board. The front part 121a of signal terminal 121 is used for mating with a mating signal terminal of the mating connector, and the rear part 121b of signal terminal 121 is used for connecting to the circuit board. The front part 131a of the power terminal 131 is used for mating with a mating power terminal of the mating connector, and the rear part 131b of the power terminal 131 is used for connecting to the circuit board.

In the illustrated embodiments, the shielding shell 11 has four sockets 111, and the four sockets 111 are arranged in an array of two rows and two columns. The connector includes three signal terminal modules 12 and one power terminal module 13.

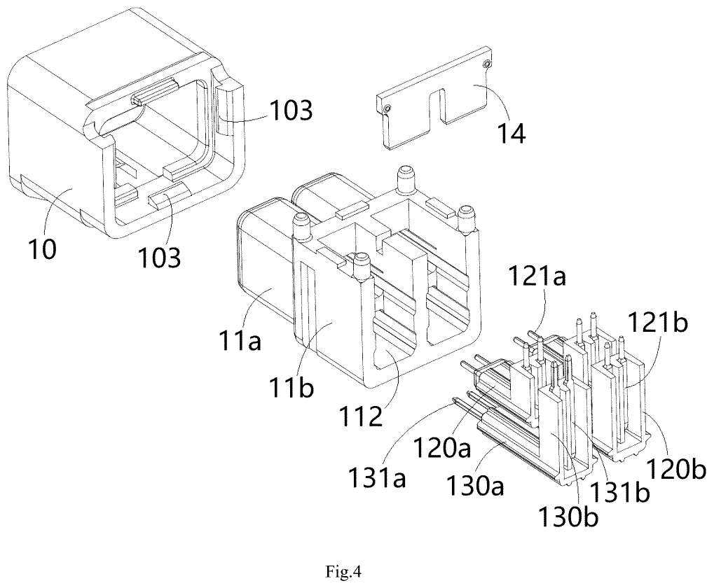

As shown in FIGS. 3 and 4, in the illustrated embodiments, two vertically extended accommodating slots 112 are formed in the rear shell part 11b, and each accommodating slot 112 is communicated with two vertically adjacent sockets 111. The rear parts of terminal modules 12 and 13 extend vertically, and the rear parts of the two adjacent vertical terminal modules 12 and 13 are accommodated in the corresponding accommodating slots 112 of the rear shell part 11b.

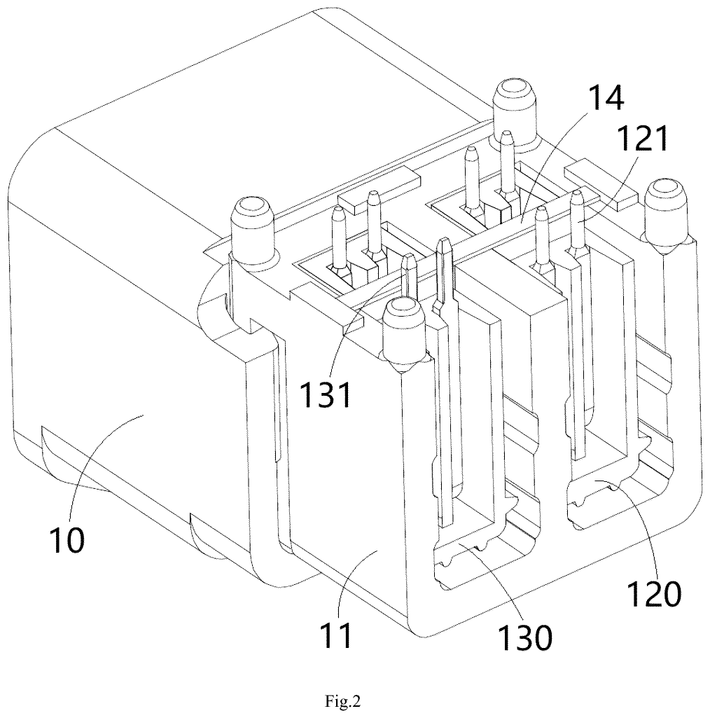

As shown in FIGS. 2 to 4, in the illustrated embodiments, the connector further comprises a shielding plate 14, which is inserted into the rear shell part 11b to separate the rear parts of the two vertically adjacent terminal modules 12 and 13 from each other.

As shown in FIGS. 3 to 6, in the illustrated embodiments, the rear part 120b of the signal terminal holder 120 and the rear part 121b of the signal terminal 121 extend vertically and are accommodated in the accommodating slot 112 of the rear shell part 11b. The rear part 130b of the power terminal holder 130 and the rear part 131b of the power terminal 131 extend vertically and are accommodated in the accommodating slot 112 of the rear shell part 11b.

As shown in FIG. 3, in the illustrated embodiments, a plurality of posts 114 are formed on the bottom of the rear shell part 11b, the posts 114 are used for inserting into the holes formed in the circuit board. The ends of the rear part 121b of the signal terminal 121 and the rear part 131b of the power terminal 131 extend from the bottom of the rear shell part 11b for electrical connection to the circuit board.

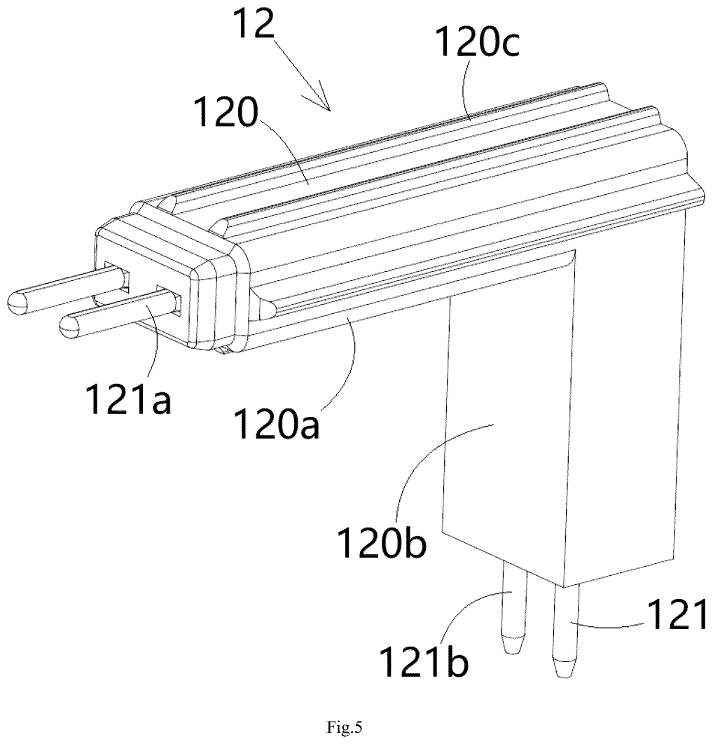

As shown in FIG. 5, in the illustrated embodiments, a plurality of first ribs 120c are formed on the outer surface of the front part 120a of the signal terminal holder 120, and the multiple first ribs 120c are distributed at intervals in the circumferential direction and extend along the horizontal direction. Multiple first ribs 120c are in contact with the inner wall of the socket 111 to reduce the contact friction between the signal terminal holder 120 and the inner wall of the socket 111. This can reduce the insertion and removal force of the signal terminal module 12.

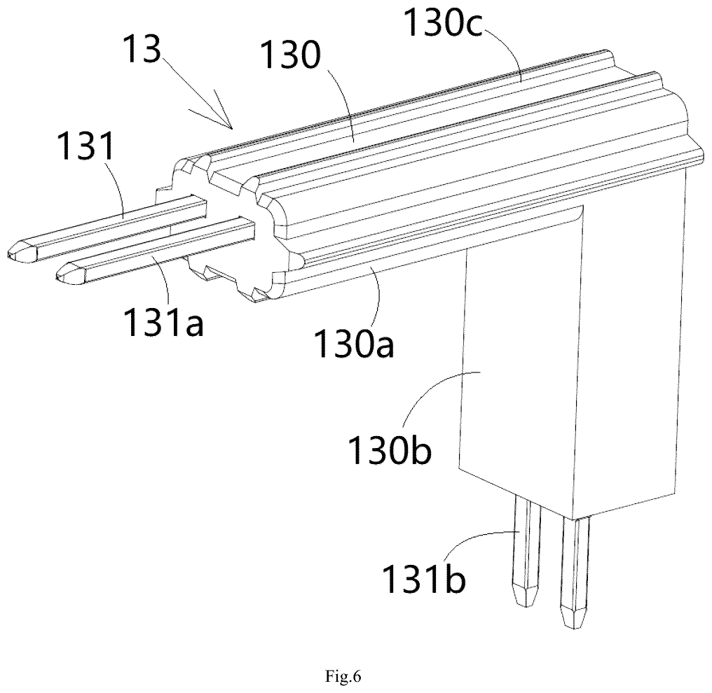

As shown in FIG. 6, in the illustrated embodiments, a plurality of second ribs 130c are formed on the outer surface of the front part 130a of the power terminal holder 130, and the multiple second ribs 130c are distributed at intervals in the circumferential direction and extend along the horizontal direction. Multiple second ribs 130c are in contact with the inner wall of socket 111 to reduce the contact friction between the power terminal holder 130 and the inner wall of socket 111. This can reduce the insertion and removal force of the power terminal module 13.

In the illustrated embodiments, the shape and size of multiple sockets 111 in the shielding shell 11 are identical, allowing the terminal modules 12 and 13 to be inserted into any of the multiple sockets 111.

As shown in FIGS. 2 to 4, in the illustrated embodiments, the connector further comprises an insulation shell 10, which is sheathed outside the shielding shell 11. A buckle 103 is formed on the inner side of the insulation shell 10, and a groove 113 is formed on the outer side of the shielding shell 11. The buckle 103 is engaged with the groove 113 to fix the insulation shell 10 to the shielding shell 11.

In the illustrated embodiments, the shielding shell 11 is an integral piece, for example, the shielding shell 11 can be an integral die cast.

In another exemplary embodiment of the present invention, a connector assembly is also disclosed. The connector assembly includes: the aforementioned connector and a mating connector. The mating connector is mated with the connector.

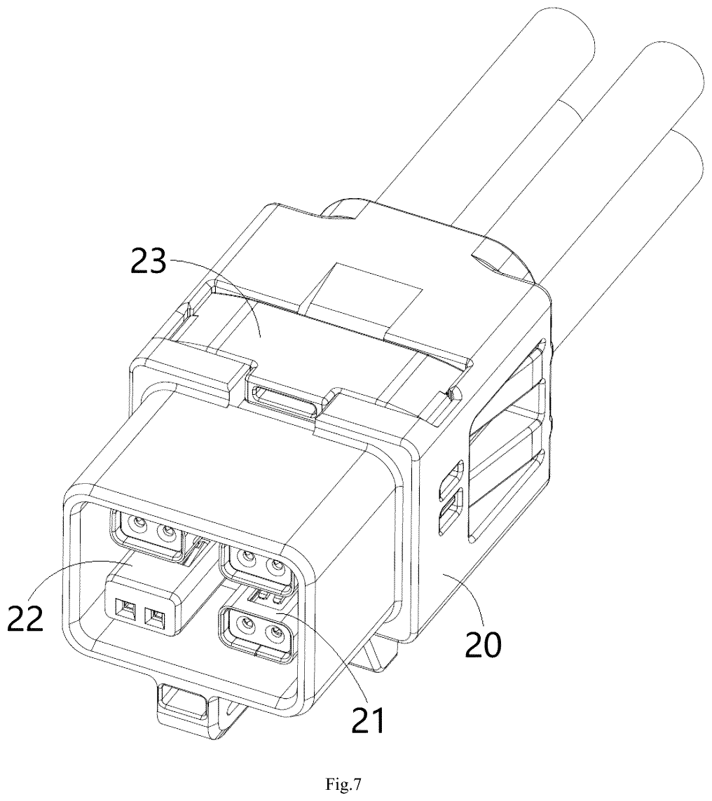

As shown in FIGS. 7 to 12, in an exemplary embodiment of the present invention, a connector is disclosed. The connector according to this embodiment includes a housing 20 and multiple terminal modules 21 and 22. The housing 20 is formed with a plurality of mounting holes 201. A plurality of terminal modules 21 and 22 are respectively inserted into multiple mounting holes 201. The terminal modules 21 and 22 include a signal terminal module 21 for transmitting signals and a power terminal module 22 for transmitting power.

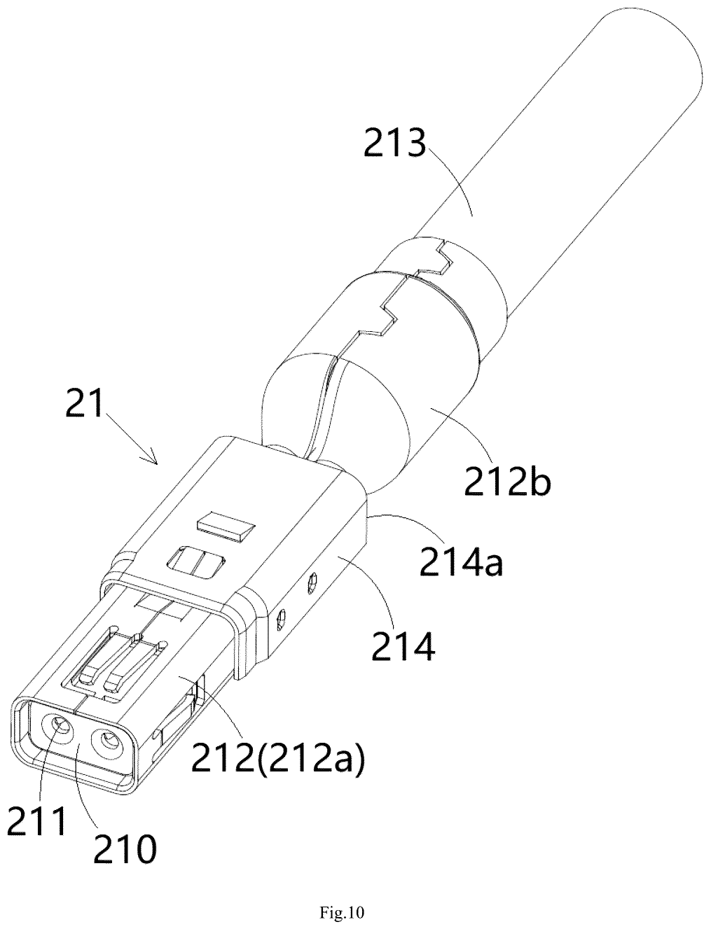

As shown in FIG. 10, in the illustrated embodiments, the signal terminal module 21 comprises a shielding shell 212, a signal terminal holder 210, and a signal terminal 211. The signal terminal holder 210 is provided in the shielding shell 212. The signal terminal 211 is set in the signal terminal holder 210. The power terminal module 22 includes a power terminal holder 220 and a power terminal 221 set in the power terminal holder 220.

As shown in FIG. 10, in the illustrated embodiments, the signal terminal module 21 further includes a signal cable 213, one end of which extends into the shielding shell 212 and is electrically connected to the signal terminal 211. The shielding shell 212 comprises a front part 212a and a rear part 212b. The signal terminal holder 210 is installed in the front part 212a of the shielding shell 212, and the rear part 212b of the shielding shell 212 is crimped onto the signal cable 213 and electrically connected to the shielding layer of the signal cable 213.

In the illustrated embodiments, the shielding shell 212 is an integral piece. For example, the shielding shell 212 can be an integral stamped piece.

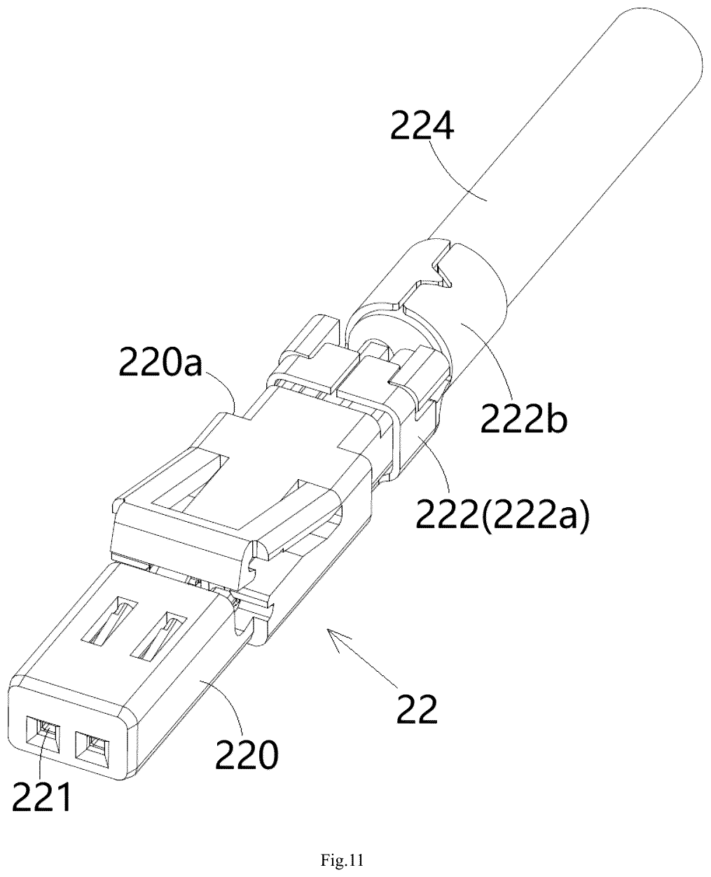

As shown in FIG. 11, in the illustrated embodiments, the power terminal module 22 further includes a power cable 224 and a crimping component 222. The power cable 224 is connected to the power terminal 221. The front end 222a of the crimping component 222 is crimped onto the power terminal holder, and the rear end 222b of the crimping component 222 is crimped onto the power cable 224.

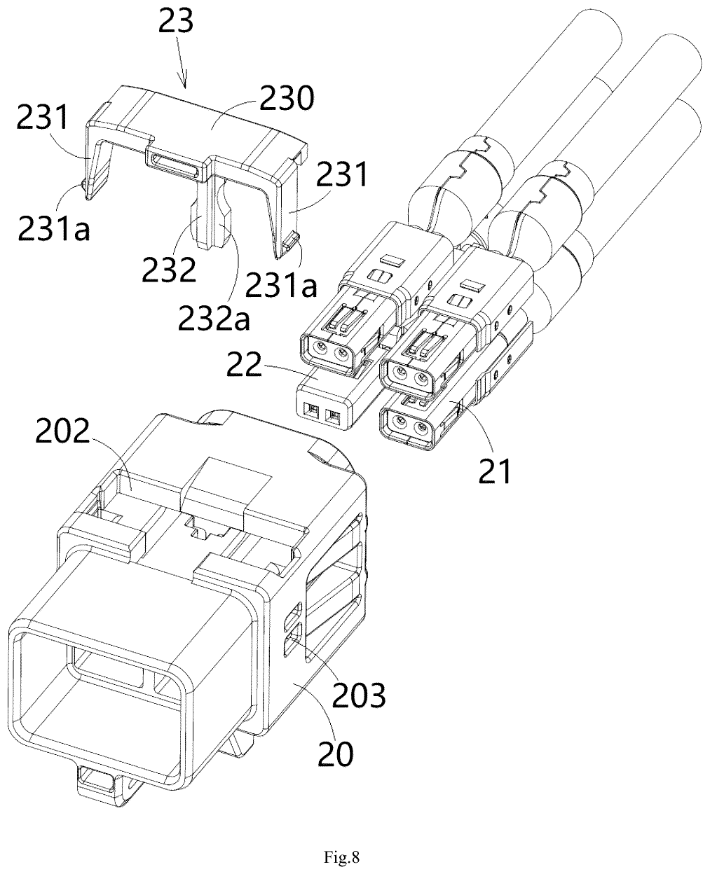

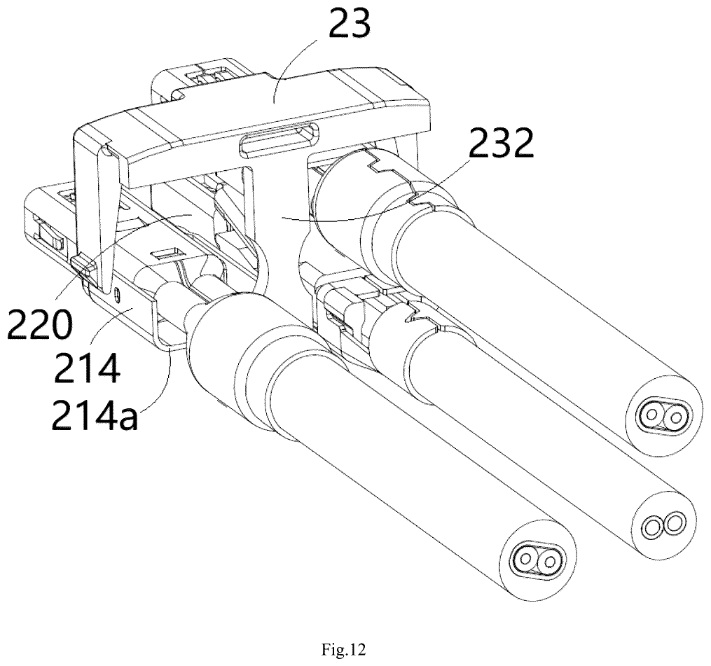

As shown in FIGS. 8 and 12, in the illustrated embodiments, the connector further comprises a locking member 23, which is inserted into a slot 202 formed in the housing 20 and simultaneously abuts against multiple terminal modules 21 and 22 to lock the multiple terminal modules 21 and 22 in the mounting holes 201 of the housing 20.

As shown in FIG. 8, in the illustrated embodiments, the locking member 23 includes a base plate 230, a pair of cantilever parts 231 respectively connected to the two ends of the base plate 230, a locking part 232 which is connected to the base plate 230 and is located between the pair of cantilever parts 231. A protrusion 231a is formed on the end of the cantilever part 231, and a groove 203 is formed on the housing 20 to engage with the protrusion 231a to lock the locking member 23 to the housing 20. The locking part 232 simultaneously abuts against multiple terminal modules 21 and 22 to lock them in the mounting holes 201 of the housing 20.

As shown in FIG. 10, in the illustrated embodiments, the signal terminal module 21 further includes a locking shell 214, which is installed on the front part 212a of the shielding shell 212. The edge part 232a of the locking part 232 of the locking member 23, as shown in FIGS. 8 and 12, is pressed against the rear end face 214a of the locking shell 214 to lock the signal terminal module 21 in the mounting hole 201 of the housing 20.

As shown in FIG. 11, in the illustrated embodiments, a step surface 220a is formed on the power terminal holder 220, and the edge part 232a of the locking part 232 of the locking member 23 is pressed against the step surface 220a of the power terminal holder 220 to lock the power terminal module 22 in the mounting hole 201 of the housing 20.

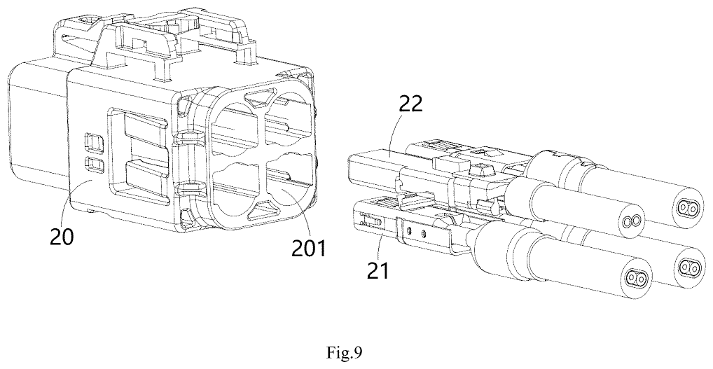

As shown in FIG. 9, in the illustrated embodiments, the housing 20 has four mounting holes 201, and the four mounting holes 201 are arranged in an array of two rows and two columns. In the illustrated embodiment, the connector includes three signal terminal modules 21 and one power terminal module 22.

In another exemplary embodiment of the present invention, a connector assembly is also disclosed. The connector assembly includes: the aforementioned connector and a mating connector, the mating connector is mated with the connector.

In the aforementioned exemplary embodiments of the present invention, the connector comprises a signal terminal module for transmitting signals and a power terminal module for transmitting power, so that the connector can be applied to situations that require both signal transmission and power transmission, thereby expanding the scope of use of the connector.

It should be appreciated for those skilled in this art that the above embodiments are intended to be illustrative, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and preceded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

1. A connector, comprising:
a shielding shell having a plurality of sockets; and
a plurality of terminal modules respectively inserted into the sockets, the terminal modules include a signal terminal module for transmitting signals and a power terminal module for transmitting power, the signal terminal module includes a signal terminal holder and a signal terminal provided in the signal terminal holder, the power terminal module includes a power terminal holder and a power terminal provided in the power terminal holder.

2. The connector according to claim 1, wherein the shielding shell has a front shell part and a rear shell part, the sockets are formed in the front shell part and extend in a horizontal direction, a plurality of front parts of the terminal modules extend in the horizontal direction and are respectively inserted into the sockets of the front shell part.

3. The connector according to claim 2, wherein a front part of the signal terminal holder and a front part of the signal terminal extend in the horizontal direction and are inserted into sockets of the front shell part, a front part of the power terminal holder and a front part of the power terminal extend in the horizontal direction and are inserted into sockets of the front shell part.

4. The connector according to claim 3, wherein the front shell part of the shielding shell is matable with a mating shielding shell of a mating connector, the rear shell part of the shielding shell is connectable to a circuit board, the front part of the signal terminal is matable with a mating signal terminal of the mating connector and a rear part of the signal terminal is connectable to the circuit board, the front part of the power terminal is matable with a mating power terminal of the mating connector and a rear part of the power terminal is connectable to the circuit board.

5. The connector according to claim 4, wherein the shielding shell has four sockets, the four sockets are arranged in an array of two rows and two columns, the signal terminal module is one of three signal terminal modules and the power terminal module is the only power terminal module.

6. The connector according to claim 5, wherein a pair of vertically extending accommodating slots are formed in the rear shell part, each accommodating slot is communicated with a pair of vertically adjacent sockets, a rear part of each of the terminal modules extends vertically, and a pair of rear parts of vertically adjacent terminal modules are respectively accommodated in the accommodating slots of the rear shell part.

7. The connector according to claim 6, further comprising a shielding plate inserted into the rear shell part to separate the rear parts of the vertically adjacent terminal modules.

8. The connector according to claim 3, wherein:
a plurality of first ribs are formed on an outer surface of the front part of the signal terminal holder, the first ribs are distributed at intervals in a circumferential direction and extend along the horizontal direction, the first ribs are in contact with an inner wall of the socket; and/or
a plurality of second ribs are formed on an outer surface of the front part of the power terminal holder, the second ribs are distributed at intervals in the circumferential direction and extend along the horizontal direction, the second ribs are in contact with the inner wall of the socket.

9. The connector according to claim 1, wherein a shape and a size of the sockets in the shielding shell are identical.

10. The connector according to claim 1, further comprising an insulation shell fitted on an outside of the shielding shell, a buckle is formed on an inner side of the insulation shell, a groove is formed on an outer side of the shielding shell, the buckle is engaged with the groove to fix the insulation shell to the shielding shell.

11. The connector according to claim 1, wherein the shielding shell is an integral piece.

12. A connector, comprising:
a housing having a plurality of mounting holes; and
a plurality of terminal modules disposed in the mounting holes, the terminal modules include a signal terminal module for transmitting signals and a power terminal module for transmitting power, the signal terminal module includes a shielding shell, a signal terminal holder disposed in the shielding shell, and a signal terminal disposed in the signal terminal holder, the power terminal module includes a power terminal holder and a power terminal disposed in the power terminal holder.

13. The connector according to claim 12, wherein the signal terminal module includes a signal cable, an end of the signal cable extends into the shielding shell and is electrically connected to the signal terminal, the shielding shell has a front part and a rear part, the signal terminal holder is installed in the front part of the shielding shell, the rear part of the shielding shell is crimped onto the signal cable and electrically connected to a shielding layer of the signal cable.

14. The connector according to claim 12, wherein the shielding shell is an integral piece.

15. The connector according to claim 12, wherein the power terminal module includes a power cable electrically connected to the power terminal and a crimping component having a front end crimped onto the power terminal holder and a rear end crimped onto the power cable.

16. The connector according to claim 12, further comprising a locking member disposed in a slot formed in the housing and simultaneously pressed against the terminal modules to lock the terminal modules in the mounting holes of the housing.

17. The connector according to claim 16, wherein the locking member includes:
a base plate;
a pair of cantilever parts respectively connected to a pair of ends of the base plate; and
a locking part connected to the base plate and located between the cantilever parts, a protrusion is formed on the end of one of the cantilever parts and a slot hole is formed in the housing to engage with the protrusion to lock the locking member to the housing, the locking part is simultaneously pressed against the terminal modules to lock the terminal modules in the mounting holes of the housing.

18. The connector according to claim 17, wherein the signal terminal module includes a locking shell installed on a front part of the shielding shell, an edge part of the locking part of the locking member is pressed against a rear end face of the locking shell to lock the signal terminal module in one of the mounting holes of the housing.

19. The connector according to claim 12, wherein the housing has four mounting holes, the four mounting holes are arranged in an array of two rows and two columns, the signal terminal module is one of three signal terminal modules and the power terminal module is the only power terminal module.

20. A connector assembly, comprising:
a connector including a shielding shell having a plurality of sockets and a plurality of terminal modules respectively inserted into the sockets, the terminal modules include a signal terminal module for transmitting signals and a power terminal module for transmitting power, the signal terminal module includes a signal terminal holder and a signal terminal provided in the signal terminal holder, the power terminal module includes a power terminal holder and a power terminal provided in the power terminal holder; and
a mating connector matable with the connector.
